(19) United States
(12) Patent Application Publication
(10) Pub. No.: US 2021/0044445 A1
(43) Pub. Date: Feb. 11, 2021

(54) GROUP-BASED POLICY MULTICAST FORWARDING

(71) Applicant: HEWLETT PACKARD ENTERPRISE DEVELOPMENT LP, Houston, TX (US)

(72) Inventors: Paul Allen Bottorff, Portola Valley, CA (US); Donald Fedyk, Andover, MA (US)

(21) Appl. No.: 16/535,960

(22) Filed: Aug. 8, 2019

(51) Int. Cl. H04L 12/18; H04L 29/06; H04L 12/761

(52) U.S. Cl. CPC H04L 12/185; H04L 45/16; H04L 65/4076

(57) ABSTRACT

A method includes receiving a data packet from a source endpoint included within a source endpoint group identified by a source endpoint group policy identifier, where the data packet includes a first multicast address. The method also includes transforming the data packet into a transformed data packet that includes a second multicast address constructed using the source endpoint group policy identifier and a multicast index that specifies a multicast forwarding policy between the source endpoint group and one or more destination endpoint groups identified by one or more destination endpoint group policy identifiers. The method further includes forwarding the transformed data packet toward one or more destination endpoints included within the one or more destination endpoint groups, with the forwarding being based on the second multicast address. The data packet may be routed using a forwarding path based on a multicast forwarding tree constructed for the second multicast address.

### BACKGROUND

Multicast is a network service which allows data packets to be addressed and delivered to a group of endpoints rather than a single endpoint, which is referred to as unicast. Applications for multicast are wide ranging including, for instance, discovery of network resources and networked applications, distribution of audio and/or video services, and coordination and synchronization of things (machines, sensors, etc.) for industrial and control applications. Network topologies are evolving which build one or more overlay networks on top of wired infrastructure underlay networks, which allow virtual connections or logical links between increasing numbers of endpoints to provide various application or security benefits. Efficient multicast techniques are expected for these evolving network topologies.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion. Features of the present disclosure are illustrated by way of example and not limited in the following figures, in which like numerals indicate like elements, in which:

FIG. 1 depicts a network in which may be implemented group-based policy multicast forwarding according to one or more examples of the present disclosure;

FIG. 2 depicts a group-based policy matrix according to one or more examples of the present disclosure;

FIG. 3 depicts a flow diagram of a method for constructing a multicast forwarding tree for group-based policy multicast forwarding according to one or more examples of the present disclosure;

FIG. 4 depicts a flow diagram of a method for group-based policy multicast forwarding according to one or more examples of the present disclosure;

FIG. 5 depicts a flow diagram of a method for group-based policy multicast forwarding according to one or more examples of the present disclosure;

FIG. 6 depicts a forwarding table for use in group-based policy multicast forwarding according to one or more examples of the present disclosure;

FIG. 7 depicts a flow diagram of a method for group-based policy multicast forwarding according to one or more examples of the present disclosure;

FIG. 8 depicts a computing device within which can be implemented constructing a multicast forwarding tree and group-based policy multicast forwarding according to one or more examples of the present disclosure; and

FIG. 9 depicts a non-transitory computer-readable storage medium storing executable instructions for constructing a multicast forwarding tree and group-based policy multicast forwarding according to one or more examples of the present disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which may vary from one implementation to another. Moreover, it will be appreciated that such a development effort, even if complex and time-consuming, would be a routine undertaking for those of ordinary skill in the art having the benefit of this disclosure.

Technical barriers to efficient multicast include network overload on wireless media, excessive replication on wired media, complex signaling protocols for the construction and deployment of multicast forwarding, and multicast scope limits which do not support the needs of applications. To illustrate, two techniques for providing multicast, Ethernet Virtual Local Area Network (“VLAN”)-based multicast and Internet Protocol Independent Multicast (“PIM”) routing, each exhibit at least some of these technical barriers.

For example, VLAN-based multicast, used by some discovery protocols, may be configured to flood copies of data packets over an entire network segment, for instance an entire VLAN sub-network (“subnet”), with the data packets being filtered to determine which endpoints should receive the data packets. This may result in unnecessarily overloading some devices in a network. Additionally, this problem may be exacerbated when VLAN-based multicast extends beyond the boundary of a single VLAN, for instance to discover resources on adjoining subnets.

PIM routing provides a variety of methods for multicast distribution for both sparsely distributed receivers, using PIM Sparse Mode (“PIM-SM”), and densely distributed receivers, using PIM Dense Mode (“PIM-DM”), and solves the flooding problems of VLAN-based multicast by the use of signaling protocols. However the operational complexity and network state requirements make deployment difficult. In addition, PIM systems are poorly suited for supporting discovery protocols since PIM relies on explicit signaling, e.g., multicast joins, to attach and build the multicasts.

Disclosed herein are methods and hardware, such as a non-transitory computer-readable storage medium comprising executable instructions and a computing device, for group-based policy multicast forwarding. In an example, a method includes receiving a data packet from a source endpoint included within a source endpoint group identified by a source endpoint group policy identifier, where the data packet includes a first multicast address. The method also includes transforming the data packet into a transformed data packet that includes a second multicast address constructed using the source endpoint group policy identifier and a multicast index used to specify a multicast forwarding policy between the source endpoint group and one or more destination endpoint groups identified by one or more destination endpoint group policy identifiers. The method further includes forwarding the transformed data packet toward one or more destination endpoints included within the one or more destination endpoint groups, with the forwarding being based on the second multicast address.

Forwarding the data packet based on the second multicast address, which is constructed based on the source endpoint group identifier and the multicast index, enables a number of illustrative benefits. For example, the routing of the data packet is tied to the multicast forwarding policy specified by the multicast index which may enable multicast data packets to be routed directly to one or more destination endpoints included in the one or more destination endpoint groups specified by the multicast index, without the data packets being filtered to determine which endpoints should receive the data packets. This may eliminate network and/or device overload and excessive replication associated with flooding the network with copies of data packets and the required filtering of the data packets at the receiving end.

Additionally, examples of the present disclosure may enable multicast data packets to be routed directly to the one or more destination endpoints included in the one or more destination endpoint group specified by the multicast index, without the destination endpoints having to explicitly join a multicast group. This reduces the signaling complexity of implementing multicast, even while scaling the number of endpoints in the network, which may allow an increase in multicast scope limits to support the expanding needs of applications.

In another example, according to the present disclosure, a method includes receiving a group-based policy matrix having at least a source endpoint group policy identifier that identifies a source endpoint group, one or more destination endpoint group policy identifiers identifying one or more destination endpoint groups having included therein one or more destination endpoints, and a multicast index used to specify a multicast forwarding policy between the source endpoint group and the one or more destination endpoint groups. The method also includes constructing a multicast address using the source endpoint group policy identifier and the multicast index, and receiving an identifier, e.g., a port number, for each network attachment point for each destination endpoint included within the one or more destination endpoint groups. The method further includes constructing a multicast forwarding tree to program a forwarding path for the constructed multicast address using the identifiers for the network attachment points. The forwarding path controls multicast distribution of multicast data packets from the source endpoint group to the one or more destination endpoint groups using the constructed multicast address, which identifies the multicast forwarding policy.

Programming a forwarding path based on the multicast address which was constructed using the multicast index and using the individual network addresses of the one or more intended destination endpoints enables the routing of multicast data packets directly to the intended destination endpoints without flooding the network and without a filtering burden on receiving devices. The forwarding path also allows the routing of multicast data packets to the intended destination endpoints without these endpoints having to join a multicast group, thereby reducing signaling overhead associated with multicast implementation.

Accordingly, the present disclosure may facilitate group-based policy multicast forwarding that provides greater control of multicast forwarding than VLAN-based multicast and simpler more easily scaled operation than PIM routing. The above-mentioned example benefits may be realized whether the intended destination endpoints are included in a single subnet or a plurality of subnets. Moreover, the present disclosure can be applied to facilitate group-based policy multicast forwarding in controller-based wireless networks or in distributed underlay networks.

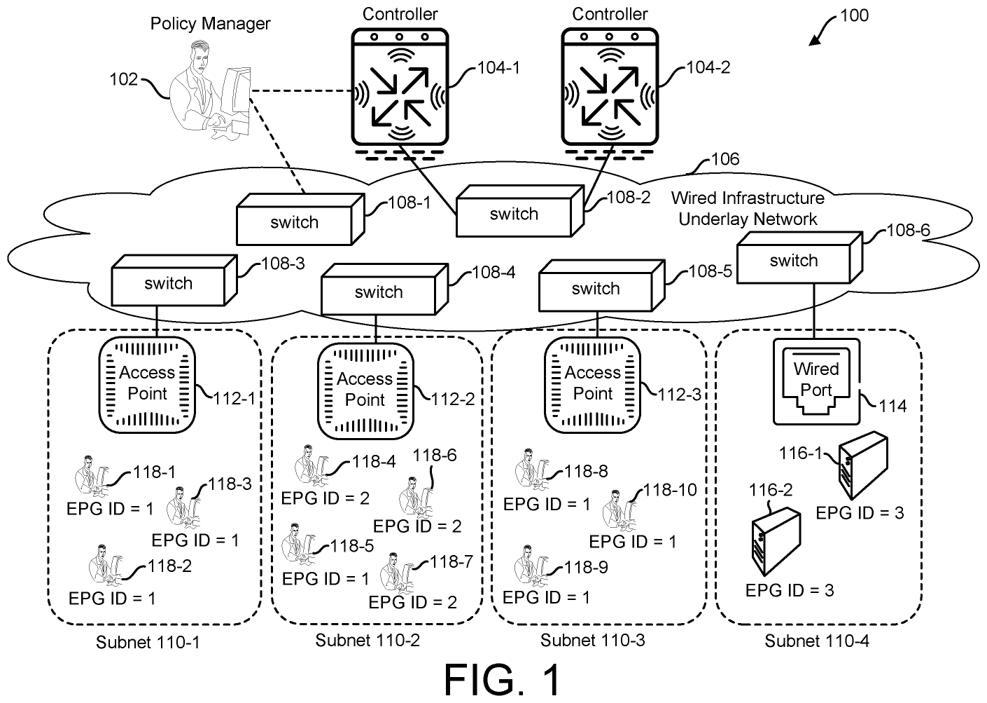

Turning now to the drawings, FIG. 1 depicts a network 100 in which may be implemented group-based policy multicast forwarding, according to one or more examples of the present disclosure. As illustrated, network 100 includes a policy manager 102 operated by an individual using a computing device; controllers 104-1 and 104-2, collectively referred to as controllers 104; a wired infrastructure underlay network 106; and subnets 110-1, 110-2, 110-3, and 110-4, collectively referred to as subnets 110. In a particular example, network 100 may be an enterprise network deploying underlay/overlay technologies to, for instance: realize controllerless mobility over attached devices; apply group-based policy management to simplify network access control; utilize network segmentation to isolate different network applications; and provide simplified network configuration.

For example, the policy manager 102 may be used to provide role- and/or device-based secure network access control of individuals, groups, devices, and/or applications to one or more overlay networks built on top of an underlay network, such as the wired infrastructure underlay network 106. The policy manager 102 may be implemented at least in part by policy management software and/or firmware (not separately shown) executing on the computing device used by the individual operating the policy manager 102, to determine and distribute forwarding policy as part of network access control. The controllers 104 may be used as distribution and enforcement points for the network access control, including distribution and enforcement of the forwarding policy. Accordingly, the policy manager 102 couples to both controllers 104 (with only one of those couplings shown). In an example, the controllers 104 have redundant functionality.

The one or more overlay networks may provide access to overlay services including, but not limited to, data packet routing (e.g., using Internet Protocol (“IP”)), multicast routing, Quality of Service, and/or other types or network virtualizations such as Internet Engineering Task Force's (“IETF's”) Network Virtualization Over Layer-3 (“NVO3”). Moreover, the one or more overlay networks may be implemented as a peer-to-peer network, an IP network, a VLAN, etc. The overlay services are provided by establishing logical communication links between endpoints connected to the network 100. The logical communication links may be established using overlay network addresses such as layer-3 (e.g., IP) addresses or layer-2 (e.g., Ethernet) addresses, which can be used by the wired infrastructure underlay network 106 to route data packets from a source endpoint to one or more destination endpoints.

An “endpoint” is an entity that may be designated by an identification tag or number and/or by a network address. An endpoint may be a computing device (such as a client device or a server device (“server”)), an application executing on a computing device, an actual physical location such as a network port, or a logical location designated by a network or software address, as some examples. A group of endpoints identified by an identifier, such as a policy identifier, is referred to as an “endpoint group.”

An endpoint may source or receive a data packet. An endpoint that sources, sends, or originates a data packet is referred to as a “source endpoint,” and an endpoint group that includes a source endpoint is referred to as a “source endpoint group.” An endpoint to which a data packet is destined or addressed, in other words an intended recipient endpoint for the data packets, is referred to as a “destination endpoint,” and an endpoint group that includes a destination endpoint is referred to as a “destination endpoint group.”

A “data packet” is a formatted unit of data carried by the network 100 and may include user data, also referred to as payload, and control information used to deliver the data packet, such as source and destination network addresses. The control information may be included in one or more headers and/or footers of the data packet.

The wired infrastructure underlay network 106, also referred to as the underlay network 106, includes a plurality of networking devices, such as switches, routers, gateways, repeaters, hubs, etc. A “networking device” refers to a physical device and its associated hardware, which may also execute software code and/or firmware, to deliver or assist in delivering data packets between endpoints within a network. Illustrated as part of the underlay network 106 are switches 108-1, 108-2, 108-3, 108-4, 108-5, and 108-6, collectively referred to as switches 108. As illustrated, in this particular example, the switches 108 are implemented as edge devices that may provide an entry point to the underlay network 106 (as an ingress routing device) and an exit point from the underlay network 106 (as an egress routing device). However, depending at least in part on the size of the enterprise and/or the number of endpoints supported and/or a geographical area covered, the underlay network 106 may include additional networking devices that may be edge devices or may be internal devices, which do not sit at the edge of the underlay network 106.

The networking devices, including the switches 108, of the underlay network 106 may implement one or more protocols to facilitate constructing and using routing/forwarding trees, routing/forwarding tables, etc., to route data packets between endpoints. Example protocols include, but are not limited to, IP (e.g., IPv4 or IPv6), Shortest Path Bridging (“SPB”), Spanning Tree Protocol (“STP”), Multiple Spanning Tree Protocol (“MSTP”), link state routing protocols (e.g., Open Shortest Path First (“OSPF”) and Intermediate System to Intermediate System (“IS-IS”), Border Gateway Protocol (“BGP”), equal-cost multi-path routing (“ECMP”), Routing Information Protocol (“RIP”), Identifier-Locator Addressing (“ILA”) for IPv6, and the like. In a particular example, the underlay network 106 is an IPv6 network based on ILA and IETF's NVO3.

As illustrated, the network 100 includes a plurality of (in this case four) network segments or subnets 110. In an example, the subnets 110 are distinguished based on network addressing. For instance, endpoints and access devices that belong to a given subnet 110 have unique IP addresses but with an identical most-significant bit group. Each of the subnets 110 has an access device that facilitates connecting endpoints of the subnets 110 to the underlay network 106 for data packet forwarding. The access devices for subnets 110-1, 110-2, and 110-3 include, respectively, access point 112-1, 112-2, and 112-3, collectively referred to as access points 112. The access device for subnet 110-4 is a wired port 114. The access points 112 enable endpoints to wirelessly connect to the underlay network 106 using any suitable wireless protocol or technology including, but not limited to, Wireless Local Area Network (“WLAN”) technologies (e.g., 802.11a/b/g/n); Wireless Metropolitan Area Network (“WMAN”) technologies (e.g., 802.16 Broadband Wireless Access WMAN standard); and Wireless Wide Area Network (“WWAN”) technologies (e.g., GSM/GPRS/EDGE and CDMA200 1×RTT). The wired port 114 facilitates a wired connection by endpoints to the underlay network 106.

As illustrated, subnets 110-1, 110-2, and 110-3 include devices collectively referred to as endpoints 118. In this example, endpoints 118 are client devices. Subnet 110-4 includes devices collectively referred to as endpoints 116. In this example, endpoints 116 are servers. More particular, subnet 110-1 includes endpoints 118-1, 118-2, and 118-3, which may wirelessly connect to the underlay network 106 using the access point 112-1. Subnet 110-2 includes endpoints 118-4, 118-5, 118-6, and 118-7, which may wirelessly connect to the underlay network 106 using the access point 112-2. Subnet 110-3 includes endpoints 118-8, 118-9, and 118-10, which may wirelessly connect to the underlay network 106 using the access point 112-3. Subnet 110-4 includes endpoints 116-1 and 116-2, which may connect to the underlay 106 using the wired port 114.

In an example, the endpoints and access devices are assigned individual network addresses, e.g., IP addresses, from a range of network addresses allocated to the subnet within which they belong and/or are connected. The individual network addresses assigned to the endpoints may be fixed or permanent (e.g., for stationary servers) or dynamic (e.g., for mobile client devices). Dynamic network addresses can change as the endpoint moves within the network 100, for instance to a different subnet within the network 100. The individual network addresses assigned to the access devices may be fixed or permanent. A network administrator, for instance the individual operating the policy manager 102, may assign the individual network addresses. The individual network addresses may be considered overlay network addresses, in one example, as they are not directly used by the underlay network 106 to forward data packets but may undergo at least a transformation to and/or replacement by an underlay network address to forward the data packets.

For instance, endpoints 118-1, 118-2, and 118-3 may be assigned dynamic individual network addresses from a range of network addresses allocated to subnet 110-1. Endpoints 118-4, 118-5, 118-6, and 118-7 may be assigned dynamic individual network addresses from a range of network addresses allocated to subnet 110-2. Endpoints 118-8, 118-9, and 118-10 may be assigned dynamic individual network addresses from a range of network addresses allocated to subnet 110-3. Endpoints 116 may be assigned fixed individual network addresses from a range of network addresses allocated to subnet 110-4.

As further illustrated, the policy manager 102 is connected to the underlay network 106 via the switch 108-1. The controllers 104 are connected to the underlay network 106 via the switch 108-2. The access points 112 are connected to the underlay network 106 via switches 108-3, 108-4, and 108-5. The wired port 114 is connected to the underlay network 106 via the switch 108-6. Moreover, the controllers 104, access points 112, and wired port 114 are shown as being outside of the underlay network 106. However, in a different example, the controllers 104, access points 112, and wired port 114 include routing functionality and are included as edge devices of the underlay network 106.

In an example, the policy manager 102 implements Group-Based Policy (“GBP”), which simplifies access control by assigning topology independent policy identifiers to identify one or more groups of endpoints, i.e., one or more endpoint groups, having a common network forwarding policy. The policy identifiers are referred to as endpoint group policy identifiers (“EPG IDs”). In an example, the EPG IDs are independent of the particular topology of the network in which the EPG IDs are used. For instance, being topology independent, the EPG IDs do not indicate location within the network 100. In a particular example, each endpoint group is identified by a unique 16-bit EPG ID value. Moreover an EPG ID used to identify a source endpoint group is referred to as a “source EPG ID,” and an EPG ID used to identify a destination endpoint group is referred to as a “destination EPG ID.”

For the example network 100, the policy manager 102 has assigned EPG IDs 1, 2, and 3 identifying three respective endpoint groups that include one or more endpoints. In this example, endpoints 118-1, 118-2, 118-3, 118-5, 118-8, 118-9, and 118-10 are included in an endpoint group identified by EPG ID 1. Endpoints 118-4, 118-6, and 118-7 are included in an endpoint group identified by EPG ID 2. Endpoints 116 are included in an endpoint group identified by EPG ID 3. It should be noted that since the EPG IDs are network topology independent, endpoints within the same endpoint group may, but need not necessarily, share the same subnet.

Access policies, particularly network forwarding policies, may be expressed in GBP as simple relationships between the EPG IDs. In an example, the relationships between the EPG IDs express both individual forwarding policies and multicast forwarding policies between endpoint groups and are included within a Group-Based Policy Matrix (“GBPM”). Accordingly, the GBPM specifies network assess based on assigned EPG IDs. In a particular example, the GBPM expresses both individual forwarding policies and multicast forwarding policies for every endpoint group within a given network, such as the network 100. Further, the policy manager 102 may be used to create and distribute the GBPM.

An “individual forwarding policy” refers to a rule that specifies whether one or more destination endpoints within a destination endpoint group are authorized or permitted to receive unicast data packets from one or more source endpoints within a source endpoint group. A “multicast forwarding policy” refers to a rule that specifies whether one or more destination endpoints within a destination endpoint group are authorized or permitted to receive multicast data packets from one or more source endpoints within a source endpoint group. In a particular example, an individual forwarding identifier is used in the GBPM to specify an individual forwarding policy between a source endpoint group and one or more destination endpoint groups. A multicast forwarding identifier is used in the GBPM to specify a multicast forwarding policy between a source endpoint group and one or more destination endpoint groups. The individual and multicast identifiers may be determined using the policy manager 102.

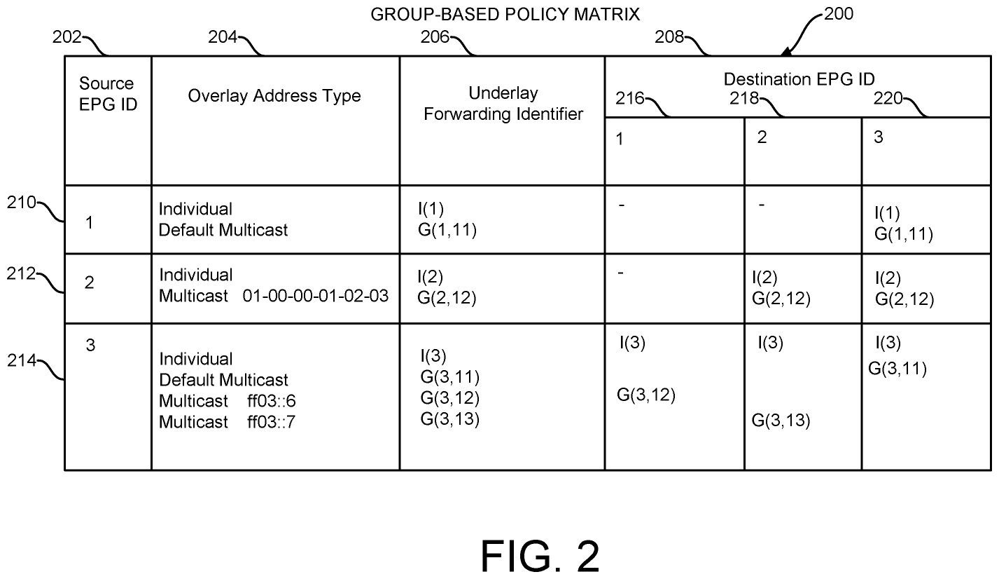

FIG. 2 depicts an example GBPM 200 that may be created for network 100. GBPM 200 includes columns 202-208 respectively labeled “Source EPG ID,” “Overlay Address Type,” “Underlay Forwarding Identifier,” and “Destination EPG ID.” The column 202 lists, as source EPG IDs, the EPG IDs 1, 2, and 3 assigned to the endpoint groups of network 100. The GBPM 200 also includes source EPG ID rows 210-214, also referred to as rows 210-214, associated with and having included therein one of the source EPG IDs. Each of the source EPG ID rows 210-214 further includes: an individual address type and one or more multicast address types in column 204; an individual forwarding identifier, in column 206, which corresponds to or is associated with the individual address type listed in that EPG ID row; and one or more multicast forwarding identifiers, column 208, which corresponds to or is associated with the one or more multicast address types listed in that EPG ID row.

In the GBPM 200, and as an example, each individual forwarding identifier includes the associated source EPG ID and has the illustrative format I(source EPG ID). Each multicast forwarding identifier includes the associated source EPG ID and a multicast index and has the illustrative format G(source EPG ID, multicast index), which is a particular tuple of the source EPG ID and the multicast index. Additionally, in a specific example, the multicast index is a 16-bit value that may be different or re-used for each source EPG ID. As illustrated, the multicast indexes are re-used for each source EPG ID. Also, including the multicast index in the multicast forwarding identifier allows the multicast index to be used to specify the multicast forwarding policy between the associated source endpoint group and one or more destination endpoint groups.

Column 208 lists, as destination EPG IDs in sub-columns 216-220, the EPG IDs 1, 2, and 3 assigned to the endpoint groups of network 100. Including the individual forwarding identifier within one or more of the sub-columns 216-220 specifies an individual forwarding policy between the corresponding source endpoint group and one or more destination endpoint groups for that EPG ID row. Including the one or more multicast forwarding identifiers within one or more of the sub-columns 216-220 specifies one or more multicast forwarding policies between the corresponding source endpoint group and one or more destination endpoint groups for that EPG ID row.

The one or more multicast address types included in the GBPM 200 may indicate a default multicast address type and/or one or more specific multicast address types. A “default multicast address type” refers to any multicast address used by a source endpoint that is not explicitly listed in the GBPM 200. A “specific multicast address type” refers to a multicast address used by a source endpoint that is explicitly listed in the GBPM 200. A specific multicast address may be, for instance, a layer-2 multicast address or a layer-3 multicast address.

As illustrated, row 210, which includes source EPG ID 1, further includes an individual forwarding identifier “I(1)” and a multicast forwarding identifier “G(1, 11)” associated with a default multicast address type. Including I(1) in sub-column 220 specifies an individual forwarding policy that destination endpoints within the destination endpoint group identified by EPG ID 3 are permitted to receive unicast data packets sent from source endpoints within the source endpoint group identified by EPG ID 1. Including G(1, 11) in sub-column 220 specifies a multicast forwarding policy that destination endpoints within the destination endpoint group identified by EPG ID 3 are permitted to receive multicast data packets sent from source endpoints within the source endpoint group identified by EPG ID 1, irrespective of the multicast address included in the original data packet.

Row 212, which includes source EPG ID 2, further includes an individual forwarding identifier “I(2)” and a multicast forwarding identifier “G(2, 12)” associated with a specific multicast address type for an Ethernet address 01-00-00-01-02-03. Including I(2) in sub-columns 218 and 220 specifies an individual forwarding policy that destination endpoints within the destination endpoint groups identified by EPG IDs 2 and 3 are permitted to receive unicast data packets sent from source endpoints within the source endpoint group identified by EPG ID 2. Including G(2, 12) in sub-columns 218 and 220 specifies a multicast forwarding policy that destination endpoints within the destination endpoint groups identified by EPG IDs 2 and 3 are permitted to receive multicast data packets sent from source endpoints within the source endpoint group identified by EPG ID 2, only when the data packets include the Ethernet address 01-00-00-01-02-03.

Row 214, which includes source EPG ID 3, further includes an individual forwarding identifier “I(3);” a multicast forwarding identifier “G(3, 11)” associated with a default multicast address type; a multicast forwarding identifier “G(3, 12)” associated with a specific multicast address type for an IPv6 address ff03::6; and a multicast forwarding identifier “G(3, 13)” associated with a specific multicast address type for an IPv6 address ff03::7. Including I(3) in sub-columns 216, 218, and 220 specifies an individual forwarding policy that destination endpoints within the destination endpoint group identified by EPG IDs 1, 2, and 3 are permitted to receive unicast data packets sent from source endpoints within the source endpoint group identified by EPG ID 3.

Including G(3, 11) in sub-column 220 specifies a multicast forwarding policy that destination endpoints within the destination endpoint group identified by EPG ID 3 are permitted to receive multicast data packets sent from source endpoints within the source endpoint group identified by EPG ID 3, for any multicast address included in the original data packet except for the explicitly listed multicast addresses of ff03::6 and ff03::7. Including G(3, 12) in sub-column 216 specifies a multicast forwarding policy that destination endpoints within the destination endpoint group identified by EPG ID 1 are permitted to receive multicast data packets sent from source endpoints within the source endpoint group identified by EPG ID 3, only when the data packets include the IPv6 address ff03::6. Including G(3, 13) in sub-column 218 specifies a multicast forwarding policy that destination endpoints within the destination endpoint group identified by EPG ID 2 are permitted to receive multicast data packets sent from source endpoints within the source endpoint group identified by EPG ID 3, only when the data packets include the IPv6 address ff03::7.

The policy manager 102 may be used to provide the GBPM 200 to the underlay network 106. One or more networking devices within the underlay network 106 may use at least some of the entries, particularly at least the source EPG IDs and the corresponding multicast indexes, within the GBPM 200 to program forwarding paths or routes that limit multicast distribution according to the multicast forwarding policies specified, at least in part, by the multicast indexes. For example, the policy manager 102 distributes the GBPM 200 to all the switches, e.g., switches 108, in the underlay network 106. In a particular example, the policy manager 102 distributes the GBPM 200 using a link state routing protocol, for instance by including the GBPM 200 in link-state advertisements (“LSAs”) of the OSPF routing protocol. Alternatively, the GBPM 200 may be distributed using other methods including, but not limited to, management objects, Command Line Interface (“CLI”) commands, or a Representational State Transfer (“REST”) application programming interface (“API”).

A control plane may then use the GBPM 200, and may use other data, to construct multicast forwarding trees and corresponding multicast forwarding tables and to program multicast forwarding routes or paths along the multicast forwarding trees, for forwarding multicast data packets. The “control plane” refers to the part of the data packet routing architecture (including networking devices and routing protocols) used to construct the network or routing topology, including forwarding trees. The control plane may also be used to construct routing and forwarding tables and to program forwarding paths, based on the constructed multicast forwarding trees. The routing and forwarding tables and programmed forwarding paths may be used by the forwarding plane, e.g., routing devices of the underlay network 106, to route multicast data packets through the underlay network 106 according to the multicast forwarding policies included in the GBPM 200, where the multicast forwarding is limited to the destination endpoints included in the destination endpoint groups specified by the multicast forwarding policies. This limited multicast distribution may be accomplished, in one example implementation, by constructing a multicast address corresponding to each source EPG ID/multicast index pair of each row of the GBPM 200, constructing a corresponding multicast forwarding tree for each constructed multicast address, and constructing one or more forwarding tables and programmed forwarding paths associated with each constructed multicast forwarding tree.

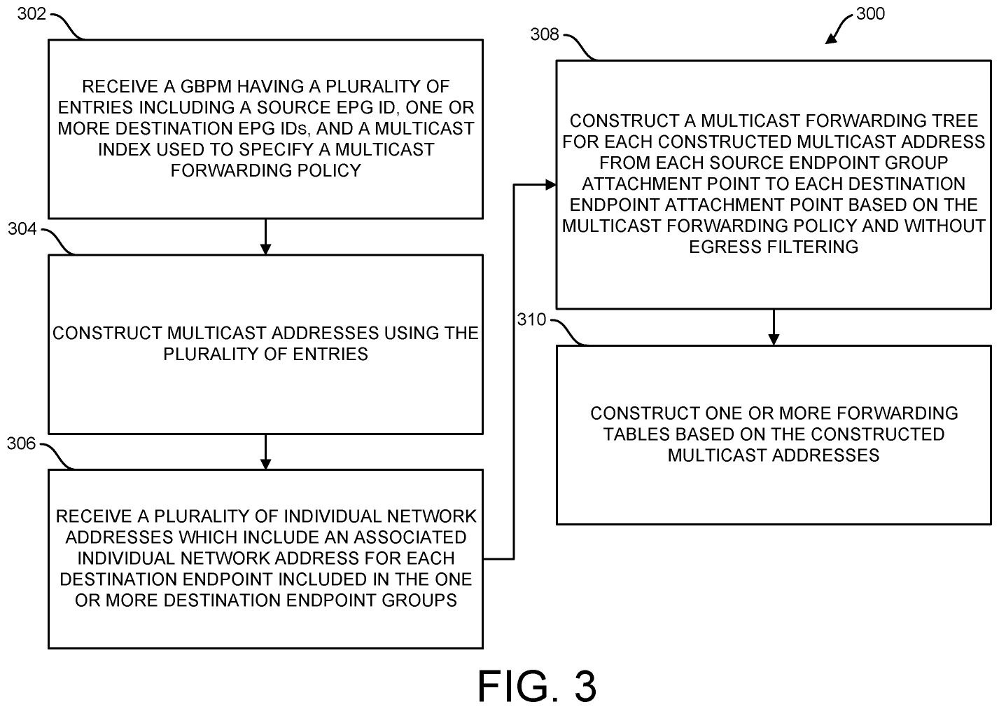

FIG. 3 depicts a flow diagram of a method 300 for constructing a multicast forwarding tree for group-based policy multicast forwarding, according to one or more examples of the present disclosure. In an example, multicast forwarding trees are constructed for each multicast entry in the GBPM 200. A computing device, such as a networking device, used in implementing the control plane may perform the method 300.

In accordance with the method 300, the computing device receives (302) a GBPM, such as the GBPM 200, which includes a plurality of entries. The plurality of entries include at least a source endpoint group policy identifier that identifies a source endpoint group, one or more destination endpoint group policy identifiers identifying one or more destination endpoint groups having included therein one or more destination endpoints, and a multicast index used to specify a multicast forwarding policy between the source endpoint group and the one or more destination endpoint groups.

In the following example, method 300 is described by reference to constructing a multicast forwarding tree associated with row 210 of the GBPM 200, which includes the source EPG ID 1 identifying a source endpoint group and the multicast forwarding identifier G(1, 11) that includes the multicast index 11. The GBPM 200 further includes destination EPG IDs 1, 2, and 3 identifying three destination endpoint groups. The multicast forwarding identifier G(1, 11), which includes the multicast index 11, specifies the multicast forwarding policy that destination endpoints within the destination endpoint group identified by EPG ID 3 are permitted to receive multicast data packets sent from source endpoints within the source endpoint group identified by EPG ID 1, irrespective of the multicast address included in the original data packet.

The computing device constructs (304) multicast addresses using the plurality of entries within the GBPM, for instance using the source EPG ID 1 and the multicast index 11. In one example, a multicast address is constructed using a network address translation technique, which may encode the source EPG ID 1 and the multicast index 11 into the constructed multicast address. The constructed address may use any format. For instance, the constructed address may conform to an IPv6 Identifier-Locator Addressing (ILA) format. However, any suitable format may be used to construct a multicast address that encodes, contains, refers to, or otherwise identifies a source EPG ID and an associated multicast index. Additionally, the multicast address may be constructed for use in a forwarding plane that adds the constructed multicast address to multicast data packets using encapsulation techniques such as Generic Network Virtualization Encapsulation (“GENEVE”), Virtual Extensible LAN Generic Protocol Extension (“VxLAN-GPE”), Generic Route Encapsulation (“GRE”), Provider Backbone Bridge (“PBB”), etc., in order to route the multicast data packets using the constructed multicast address. The constructed multicast address may be a layer-2 network address or a layer-3 network address, for instance.

In another example, additional information may be encoded, included, referred to, or otherwise identified in the constructed multicast address. For instance, the control plane may determine a multicast forwarding tree identifier that identifies a multicast forwarding tree. This multicast forwarding tree identifier may also be encoded, contained, referred to, or otherwise identified within the constructed multicast address. In a further example, a source router/switch identifier may be encoded, contained, referred to, or otherwise identified within the constructed multicast address. In a particular example, the constructed multicast address is created by encoding, containing, referring to, or otherwise identifying a three-tuple of (source EPG ID, multicast index, multicast forwarding tree identifier) within the constructed multicast address. In a further example, the constructed multicast address is created by encoding, containing, referring to, or otherwise identifying a four-tuple of (source router ID, source EPG ID, multicast index, multicast forwarding tree identifier) within the constructed multicast address.

The computing device receives (306), e.g., from the policy manager 102, an indication of one or more network attachment points associated with the one or more destination EPG IDs and may receive an indication of one or more network attachment points associated with the one or more source EPG IDs. For example, the computing device receives an indication of, e.g., an identifier for, one or more network attachment points for each destination endpoint in the one or more destination endpoint groups and may also receive an indication of, e.g., an identifier for, one or more network attachment points for source endpoints included in the source endpoint groups. With respect to building a multicast forwarding tree associated with row 210 of the GBPM 200, the computing device receives at least the identifiers for the one or more network attachment points for destination endpoints 116 and may also receive the identifiers for the one or more network attachment points for endpoints 118-1, 118-2, 118-3, 118-5, 118-8, 118-8, and 118-10. The identifiers for the one or more attachment points may be port numbers, for instance Transmission Control Protocol (“TCP”) or User Datagram Protocol (“UDP”) port numbers. In a further example, the computing device receives the port numbers for the attachment points for all the endpoints 116 and 118 attached to the network 100.

The computing device uses at least some of the received network attachment point identifiers to construct (308) a multicast forwarding tree for each multicast address constructed in block 304. The constructed multicast forwarding tree(s) are used to create one or more forwarding paths along the multicast tree from the one or more attachment points associated with the source endpoints to the one or more destination endpoints. The control plane may program the one or more forwarding paths into one or more networking devices of the underlay network 106 so that the forwarding paths are associated with the multicast addresses constructed in block 304. “Programming” a networking device with a forwarding path for a constructed multicast address refers to providing the networking device with at least a list of identifiers, e.g., port numbers, for attachment points associated with the destination endpoints for the constructed multicast address. Accordingly, upon receiving a data packet containing the constructed multicast address, the networking device may route the packet to the attachment points associated with the destination endpoints.

The constructed multicast forwarding tree, being based on the intended destination endpoints as specified by the multicast forwarding policy within the GBPM, controls routing of multicast data packets from any of the source endpoints in the source endpoint group directly to the destination endpoints within the destination endpoint group. Accordingly, no egress filtering by an egress networking device and/or access device, e.g., based on the GBPM, is needed to deliver the multicast data packets to the intended destination endpoints. Instead the multicast packet is directly routed to the intended destination. With respect to the row 210 of the GBPM 200, a multicast forwarding tree may be constructed that controls the forwarding path for delivering multicast data packets from any of the source endpoints within the endpoint group identified by EPG ID 1 directly to destination endpoints 116. The forwarding may be performed without egress filtering based on the GBPM 200 in one example. In another example, egress filtering is optionally performed.

The multicast forwarding tree may be constructed using any suitable routing protocol, for instance using one or more of the routing protocols earlier mentioned. The multicast forwarding tree may, alternatively, be constructed using manual configuration, e.g., by the individual operating the policy manager 102 or by some other network administrator. In one example, the multicast forwarding tree is a source-based tree. In another example, the multicast forwarding tree is a shared tree. Moreover, since the individual network addresses for the endpoints 116 may be static, the constructed multicast forwarding tree associated with row 210 may be static. Other multicast forwarding trees may be dynamically changed using method 300, for instance, as individual network addresses of mobile destination endpoints change.

In order to assist the forwarding plane, the computing device may construct (310) one or more forwarding tables for the constructed multicast addresses. For example, the forwarding table may be a routing table for a networking device. In another example, the forwarding table may be a network address translation or look-up table that enables a device to “construct” the multicast address created in block 304 from an overlay multicast address for including in the multicast data packets and forwarding to a networking device.

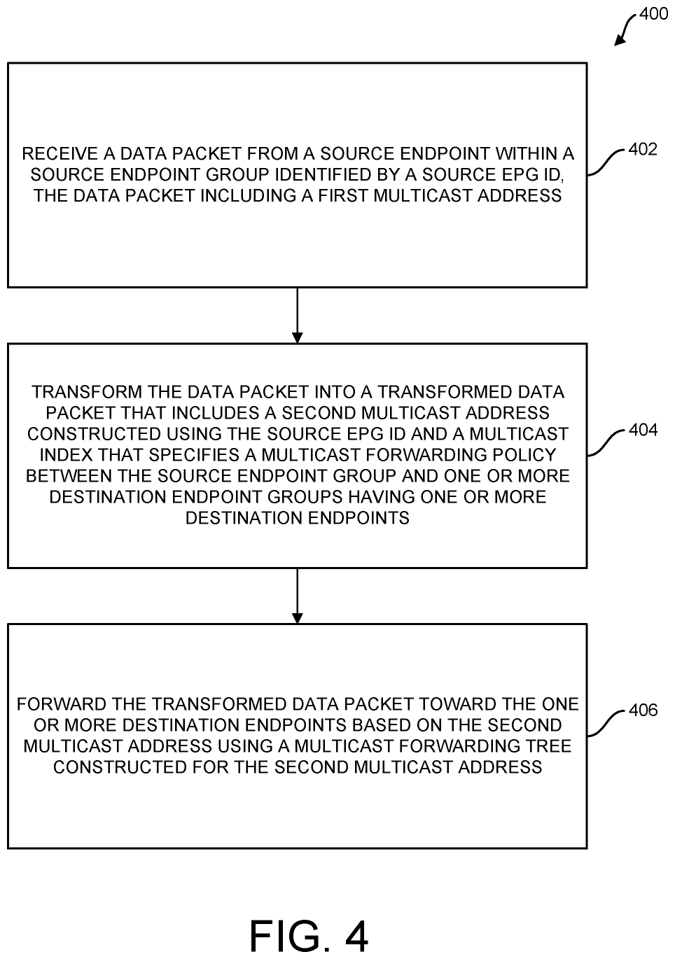

FIG. 4 depicts a flow diagram of a method 300 for group-based policy multicast forwarding, according to one or more examples of the present disclosure. Method 400 may be performed by one or more computing devices such as an access device, a networking device, or a combination thereof for use in routing multicast data packets from a source endpoint to one or more intended destination endpoints.

The computing device receives (402) a data packet from a source endpoint within a source endpoint group identified by a source EPG ID, and the data packet includes a first multicast address. This multicast address may be any multicast address assigned by the network administrator, for instance.

The computing device transforms (404) the data packet into a transformed data packet that includes a second multicast address constructed using the source EPG ID and a multicast index that specifies a multicast forwarding policy between the source endpoint group and one or more destination endpoint groups having one or more destination endpoints. The transformed data packet may be created using a network address translation technique such as IPv6 ILA or using an encapsulation technique. The transformed data packet may also be created using a forwarding or look-up table that may be indexed using the individual network address of the source endpoint to determine the source EPG ID and corresponding second multicast address.

The computing device may then forward (406) the transformed data packet toward the one or more destination endpoints based on the second multicast address. In an example, a networking device, e.g., a relay of a switch, performing the method 400, routes the transformed data packet along a multicast forwarding tree constructed for the second multicast address using one or more forwarding paths programmed into the networking device for the second multicast address. In another example, an access device performing the method 400 forwards the transformed data packet to a networking device to route the transformed data packet toward the one or more destination endpoints along the constructed multicast forwarding tree using the one or more programmed forwarding paths.

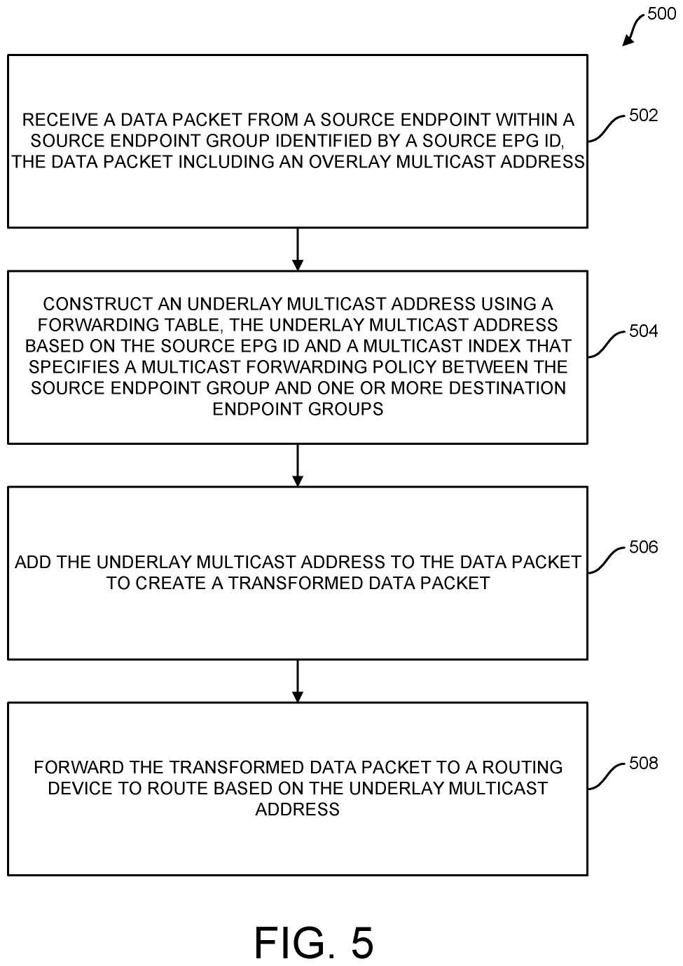

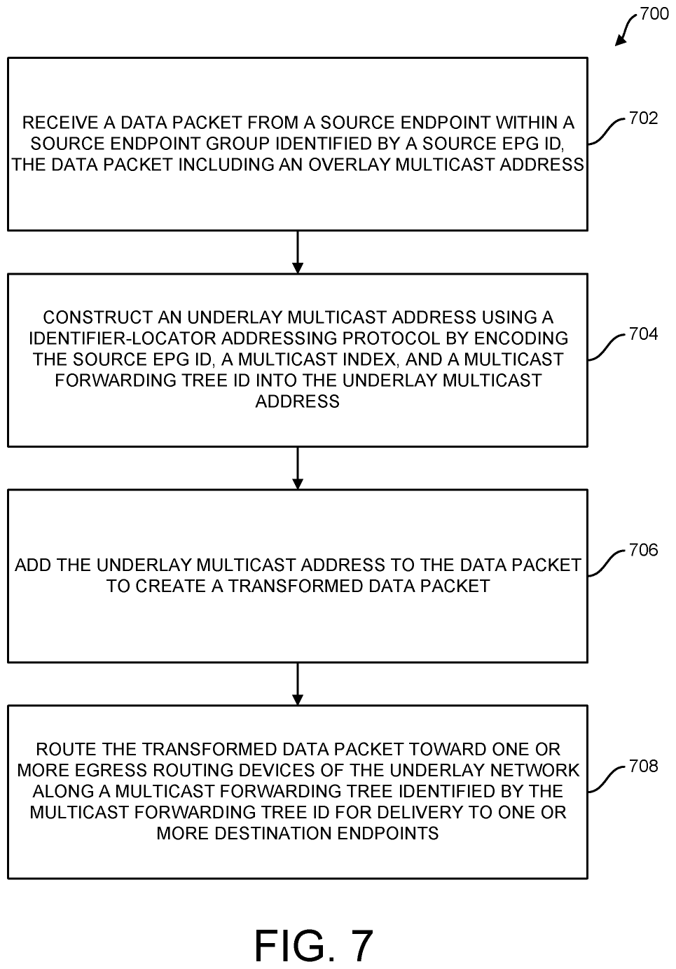

FIGS. 5 and 7 illustrate particular implementations of performing method 400. For example, FIG. 5 illustrates an example implementation of method 400 that may be performed by an access device without routing capability and using a forwarding table. FIG. 7 illustrates an example implementation of method 400 that may be performed by a networking device using a programmed forwarding path along constructed multicast forwarding tree. Moreover, FIGS. 5-7 are explained below by reference to an example implementation for group-based policy multicast forwarding of one or more data packets from a source endpoint included in the endpoint group, of network 100, which is identified by source EPG ID 1.

FIG. 5 depicts a flow diagram of a method 500 for group-based policy multicast forwarding, according to one or more examples of the present disclosure. In the described example, method 500 is performed by access point 112-1 of subnet 110-1. Access point 112-1 receives (502) a data packet from source endpoint 118-1 within the source endpoint group identified by EPG ID 1. The data packet includes an overlay multicast address assigned by a network administrator.

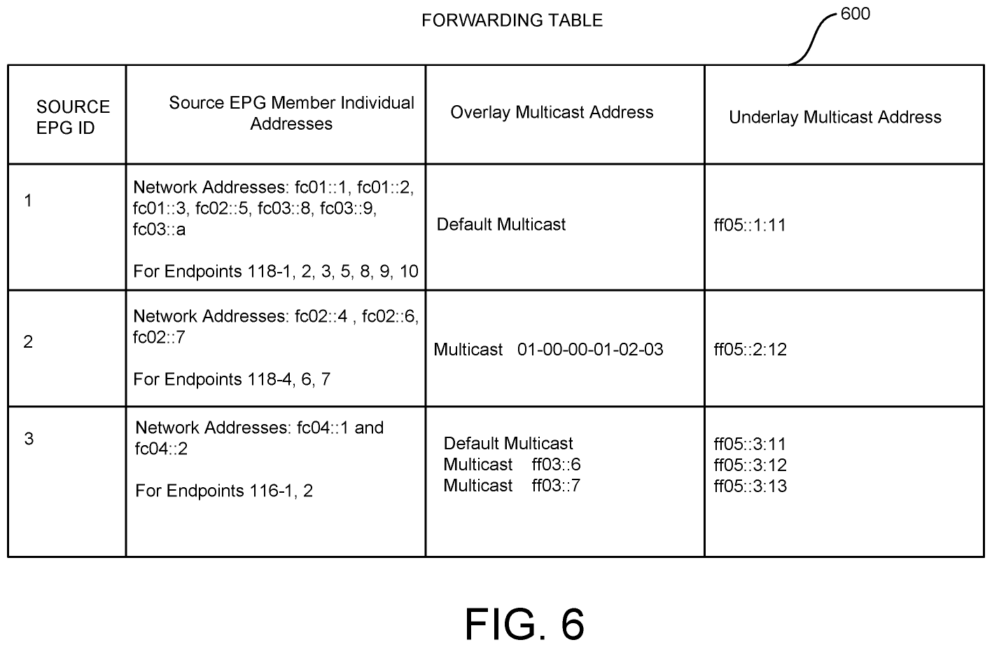

Access point 112-1 constructs (504) an underlay multicast address using a forwarding table to look-up the underlay multicast address. In an example, the access point 112-1 constructs the underlay multicast address using a forwarding table 600 depicted in FIG. 6. A column labeled “Source EPG ID” lists the source EPG IDs 1, 2, and 3 for the source endpoint groups of the network 100. A column labeled “Source EPG Individual Addresses” lists for each of the source EPG IDs 1, 2, and 3 the individual network addresses for all the endpoints included in the corresponding endpoint group. A column labeled “Overlay Multicast Address” lists for each of the source EPG IDs 1, 2, and 3 an indication of whether the multicast data packets received from the source endpoints include overlay multicast addresses of the default type or of the specific type. For overlay multicast addresses of the specific type, the specific multicast address is listed so that the access device may filter out data packets that include other multicast addresses. A column labeled “Underlay Multicast Address” lists the constructed underlay multicast address for each of the source EPG IDs 1, 2, and 3.

In a particular example, the access point 112-1 previously received the forwarding table 600 from the switch 108-3, after having been constructed by the control plane in the course of constructing the multicast forwarding tree associated with the underlay multicast address. In this example, constructing the underlay multicast address may include the access point 112-1 accessing the forwarding table 600, which may be stored in a memory resource of the access point 112-1. The access point 112-1 may retrieve the individual network address of the endpoint 118-1 from the received data packet, for instance from a header of the data packet. The access point 112-1 may use the retrieved individual network address to index the forwarding table 600 and determine the source EPG ID associated with the data packet and the constructed underlay multicast address for the source EPG ID.

In another example, the received data packet includes the source EPG ID, which can be used to index the forwarding table 600 to retrieve the constructed underlay multicast address. Accordingly, the forwarding table 600 need not include the column labeled “Source EPG Individual Addresses.” In the example where the data packet includes the source EPG ID, the forwarding table 600 may include columns labeled “Source EPG ID,” “Overlay Multicast Address,” and “Multicast Index.” In this case, the forwarding table 600 may be indexed using the source EPG ID to retrieve the corresponding multicast index, which the access point 112-1 may use to construct the underlay multicast address. In the example where the data packet does not contain the source EPG ID, the forwarding table 600 may include columns labeled “Source EPG ID,” “Source EPG Individual Addresses,” “Overlay Multicast Address,” and “Multicast Index.” In this case, the forwarding table 600 may be indexed using the individual network address of the source endpoint to retrieve the source EPG ID and multicast index in order to construct the underlay multicast address.

Turning again to the method 500, upon constructing the underlay multicast address, the access point 112-1 adds (506) the underlay multicast address to the data packet, for instance in a new header of the data packet using an encapsulation technique. This creates a transformed data packet. Alternatively, the access point 112-1 adds the underlay multicast address to the data packet as part of a translation technique. The access point 112-1 forwards (508) the transformed data packet to the switch 108-3 to route based on the underlay multicast address. In an example, the switch 108-3, as an ingress routing device of the underlay network 106, may route the transformed data packet toward an egress routing device, in this case wired port 114, to deliver to the endpoints 116 according to the multicast forwarding policy specified by the multicast index. The routing may be based on or controlled by a forwarding path programmed into a relay of the switch 108-3 by the control plane.

FIG. 7 depicts a flow diagram of a method 700 for group-based policy multicast forwarding, according to one or more examples of the present disclosure. In the described example, method 700 is performed by switch 108-3 connected to access point 112-1 of subnet 110-1. Switch 108-3 receives (702) a data packet from source endpoint 118-1 within the source endpoint group identified by EPG ID 1. The data packet is received via the access point 112-2 and includes an overlay multicast address assigned by a network administrator.

In this particular example, the switch 108-3 constructs (704) the underlay multicast address using an ILA technique by encoding the source EPG ID, a multicast index, and a multicast forwarding tree ID into the underlay multicast address. The switch 108-3 may have stored the information for constructing the underlay multicast address when implementing the control plane to construct the multicast forwarding trees. However, in other examples, the switch 108-3 may construct the underlay multicast address using other means, for instance as earlier described including using a forwarding table.

Upon constructing the underlay multicast address, the switch 108-3 adds (706) the underlay multicast address to the data packet. This creates a transformed data packet. The switch 108-3, as an ingress routing device of the underlay network 106, routes the transformed data packet toward an egress routing device, in this case wired port 114, to deliver to the endpoints 116 according to the multicast forwarding policy specified by the multicast index. The transformed data packet is routed using a forwarding path, with associated an associated port number for the wired port 114, along the multicast forwarding tree identified by the multicast forwarding tree ID.

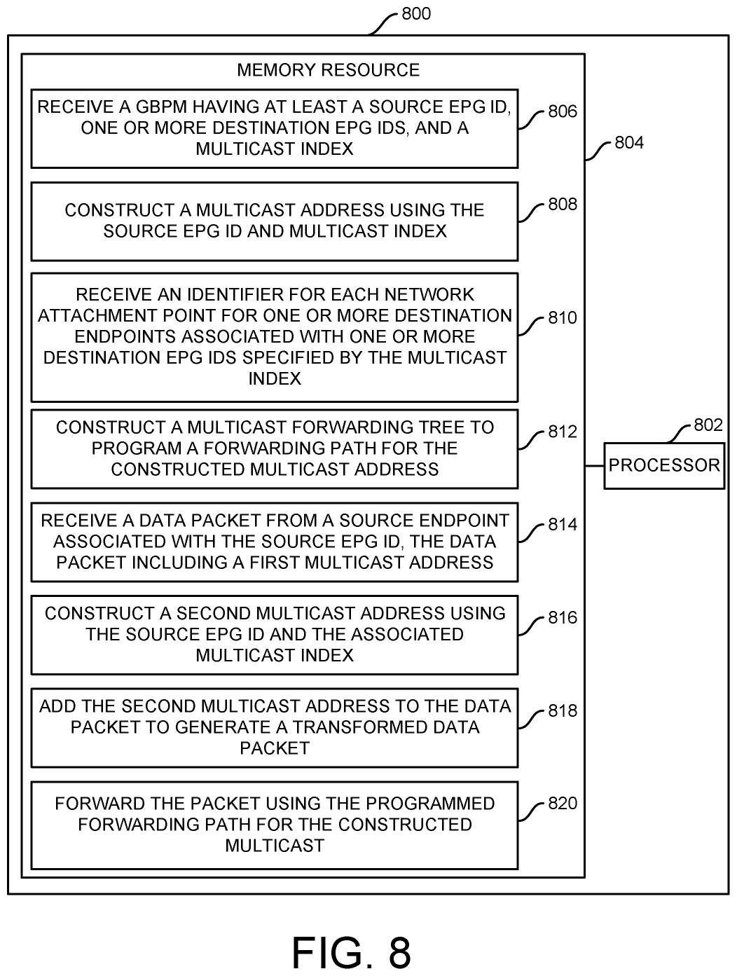

FIG. 8 depicts a computing device 800 within which can be implemented constructing a multicast forwarding tree and group-based policy multicast forwarding, according to one or more examples of the present disclosure. As illustrated, the computing device 800 includes hardware of a processor 802 and a memory resource 804, which are operatively coupled. In the example illustrated, the computing device 800 performs protocols to assist in implementing the control plane and the forwarding plane. However, in another example, only the control plane or the forwarding plane is implemented in part by the computing device 800.

The processor 802 may contain one or more hardware processors, where each hardware processor may have a single or multiple processor cores. Examples of processors include, but are not limited to, a central processing unit (CPU) and a microprocessor. Although not illustrated in FIG. 8, the processing elements that make up processor 802 may also include one or more of other types of hardware processing components, such as graphics processing units (GPU), application specific integrated circuits (ASICs), field-programmable gate arrays (FPGAs), and/or digital signal processors (DSPs).

The memory resource 804 may be a non-transitory medium configured to store various types of data. For example, memory resource 804 may include one or more storage devices that include a non-volatile storage device and/or volatile memory. Volatile memory, such as random-access memory (RAM), can be any suitable non-permanent storage device. The non-volatile storage devices can include one or more disk drives, optical drives, solid-state drives (SSDs), tape drives, flash memory, read only memory (ROM), and/or any other type of memory designed to maintain data for a duration of time after a power loss or shut down operation.

The non-volatile storage devices of the memory resource 804 may be used to store instructions that may be loaded into the RAM when such programs are selected for execution. In an example, the memory resource 804 stores executable instructions that, when executed by the processor 802, cause the processor 802 to perform one or more methods or portions thereof for constructing a multicast forwarding tree and group-based policy multicast forwarding. In a particular example, the executable instructions may cause the processor 802 to perform one or more of the methods 300, 400, 500, or 700 or portions thereof in accordance with the present disclosure. As illustrated, the memory resource 804 stores executable instructions 806-820. In an example, instructions 806-812 may be executed when implementing the control plane, and instructions 814-820 may be executed when implementing the forwarding plane.

Particularly, instruction 806, when executed by the processor 802, causes the processor 802 to receive a GBPM having at least a source EPG ID, one or more destination EPG IDs, and a multicast index. Instruction 808, when executed by the processor 802, causes the processor 802 to construct a multicast address using the source EPG ID and the multicast index. Instruction 810, when executed by the processor 802, causes the processor 802 to receive an identifier, e.g., a port number, for each network attachment point for one or more destination endpoints associated with the one or more destination EPG IDs. Instruction 812, when executed by the processor 802, causes the processor 802 to construct a multicast forwarding tree to program a forwarding path for the constructed multicast address using the identifiers for each network attachment point.

Instruction 814, when executed by the processor 802, causes the processor 802 to receive a data packet from a source endpoint associated with the source EPG ID (for which the multicast forwarding tree was constructed). The data packet includes a first multicast address. Instruction 816, when executed by the processor 802, causes the processor 802 to construct a second multicast address using the source EPG ID and an associated multicast index. Instruction 818, when executed by the processor 802, causes the processor 802 to add the second multicast index to the data packet to generate a transformed data packet. Instruction 820, when executed by the processor 802, causes the processor 802 to route the transformed data packet along the constructed multicast forwarding tree using the programmed forwarding path.

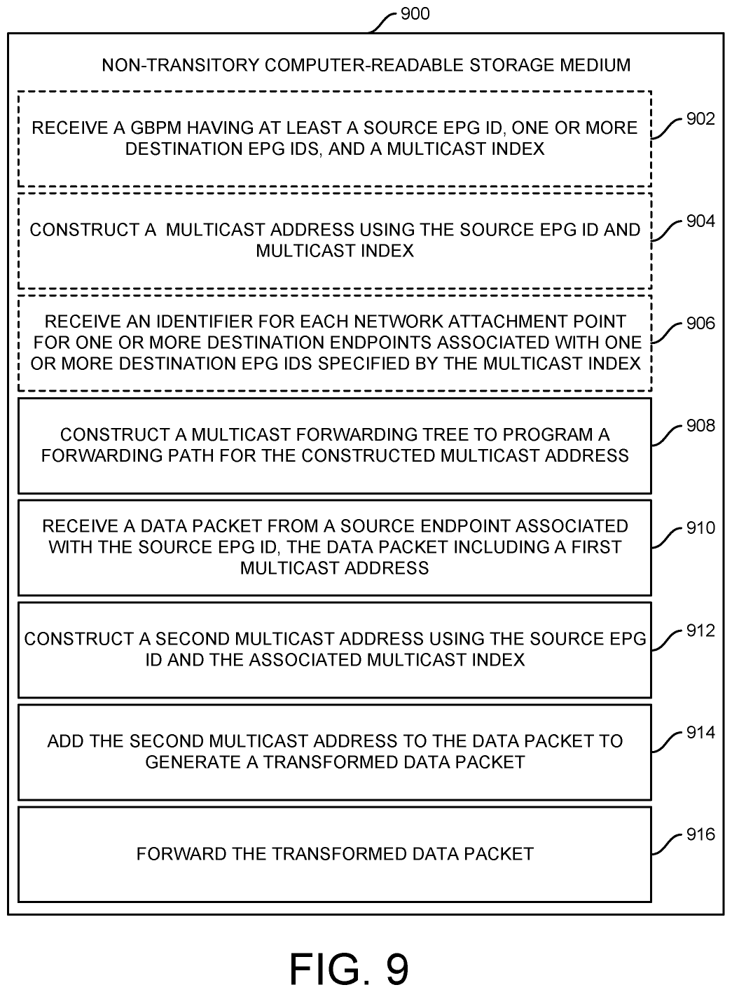

FIG. 9 depicts a non-transitory computer-readable storage medium 900 storing executable instructions for constructing a multicast forwarding tree and group-based policy multicast forwarding, according to one or more examples of the present disclosure. In an example, the non-transitory computer-readable storage medium 900 stores executable instructions that, when executed by a processor, such as the processor 802, cause the processor to perform one or more methods or portions thereof for constructing a multicast forwarding tree and group-based policy multicast forwarding. In a particular example, the executable instructions may cause the processor to perform one or more of the methods 300, 400, 500, or 700 or portions thereof in accordance with the present disclosure. As illustrated, the non-transitory computer-readable storage medium 900 stores executable instructions 902-916. In an example, instructions 902-908 may be executed when implementing the control plane, and instructions 910-916 may be executed when implementing the forwarding plane.

Particularly, instruction 902, when executed by the processor 802, causes the processor 802 to receive a GBPM having at least a source EPG ID, one or more destination EPG IDs, and a multicast index. Instruction 904, when executed by the processor 802, causes the processor 802 to construct a multicast address using the source EPG ID and the multicast index. Instruction 906, when executed by the processor 802, causes the processor 802 to receive an identifier, e.g., a port number, for each network attachment point for one or more destination endpoints associated with the one or more destination EPG IDs. Instruction 908, when executed by the processor 802, causes the processor 802 to program a forwarding path for the constructed multicast address using the identifiers for each network attachment point.

Instruction 910, when executed by the processor 802, causes the processor 802 to receive a data packet from a source endpoint associated with the source EPG ID (for which the multicast forwarding tree was constructed). The data packet includes a first multicast address. Instruction 912, when executed by the processor 802, causes the processor 802 to construct a second multicast address using the source EPG ID and an associated multicast index. Instruction 914, when executed by the processor 802, causes the processor 802 to add the second multicast index to the data packet to generate a transformed data packet. Instruction 916, when executed by the processor 802, causes the processor 802 to forward the transformed data packet. For example, when the processor 802 of a networking device 800 executes instructions 902-914, the instruction 916 may cause the processor 802 to route the transformed data packet using the programmed forwarding path. However, when the processor 802 of an access device 800 executes instructions 910-914 but not instructions 902-908, the instruction 916 may cause the processor 802 to forward the data packet to a networking device to route the transformed data packet using the programmed forwarding path.

The non-transitory computer-readable storage medium 900 may be any available medium that may be accessed by a computing device. By way of example, the non-transitory computer-readable storage medium 900 may include RAM, ROM, EEPROM, CD-ROM or other optical disk storage, magnetic disk storage or other magnetic storage devices, or any other medium that may be used to carry or store desired program code in the form of instructions or data structures and that may be accessed by a computing device. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

As used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method comprising:
receiving a data packet from a source endpoint included within a source endpoint group identified by a source endpoint group policy identifier, the data packet comprising a first multicast address;
transforming the data packet into a transformed data packet comprising a second multicast address constructed using the source endpoint group policy identifier and a multicast index used to specify a multicast forwarding policy between the source endpoint group and one or more destination endpoint groups identified by one or more destination endpoint group policy identifiers; and
forwarding the transformed data packet toward one or more destination endpoints included within the one or more destination endpoint groups, the forwarding based on the second multicast address.

2. The method of claim 1, wherein the transformed data packet is forwarded toward the one or more destination endpoints using a programmed forwarding path that is based on a multicast forwarding tree constructed for the second multicast address.

3. The method of claim 2, further comprising the programmed forwarding path controlling routing of the transformed data packet to one or more egress routing devices of a wired infrastructure underlay network for delivery to the one or more destination endpoints.

4. The method of claim 3, wherein forwarding the transformed data packet comprises an ingress routing device, of the underlay network, routing the transformed data packet toward the one or more egress routing devices using the programmed forwarding path.

5. The method of claim 2, further comprising the programmed forwarding path controlling routing of the transformed data packet to the one or more destination endpoints without egress filtering of the transformed data packet based on the multicast forwarding policy.

6. The method of claim 2, wherein the source endpoint group policy identifier and the multicast index are encoded into the constructed multicast address.

7. The method of claim 6, wherein a multicast forwarding tree identifier that identifies the multicast forwarding tree is encoded into the constructed multicast address.

8. The method of claim 1, wherein transforming the data packet and forwarding the transformed data packet further comprises:
constructing the second multicast address;
adding the second multicast address to the data packet to generate the transformed data packet; and
forwarding the transformed data packet to a routing device to route the transformed data packet toward the one or more destination endpoints.

9. The method of claim 1, wherein transforming the data packet and forwarding the transformed data packet further comprises:
constructing the second multicast address;
adding the second multicast address to the data packet to generate the transformed data packet; and
routing the transformed data packet toward the one or more destination endpoints.

10. The method of claim 1, wherein the second multicast address conforms to an Identifier-locator Addressing format.

11. The method of claim 1, further comprising:
prior to receiving the data packet from the source endpoint:
receiving a group-based policy matrix having a plurality of entries comprising the source endpoint group policy identifier, the one or more destination endpoint group policy identifiers, and the multicast index;
constructing the second multicast address using the plurality of entries within the group-based policy matrix; and
constructing a multicast forwarding tree to program a forwarding path based on the second multicast address, the programmed forwarding path controlling multicast distribution from the source endpoint group to the one or more destination endpoints.

12. The method of claim 11, wherein forwarding the transformed data packet comprises routing the transformed data packet toward the one or more destination endpoints using the programmed forwarding path.

13. A non-transitory computer-readable storage medium comprising executable instructions that, when executed by a processor, cause the processor to:
receive a data packet from a source endpoint included within a source endpoint group identified by a source endpoint group policy identifier, the data packet comprising a first multicast address;
construct a second multicast address using the source endpoint group policy identifier and a multicast index used to specify a multicast forwarding policy between the source endpoint group and one or more destination endpoint groups identified by one or more destination endpoint group policy identifiers;
add the second multicast address to the data packet to generate a transformed data packet; and
forward the transformed data packet toward one or more destination endpoints included within the one or more destination endpoint groups, the forwarding based on the second multicast address.

14. The non-transitory computer-readable storage medium of claim 13, wherein the executable instructions, when executed by the processor, further cause the processor to:
construct the second multicast address to have the source endpoint group policy identifier and the multicast index encoded therein.

15. The non-transitory computer-readable storage medium of claim 13, wherein the executable instructions, when executed by the processor, further cause the processor to:
prior to receiving the data packet from the source endpoint:
receive a group-based policy matrix having a plurality of entries comprising the source endpoint group policy identifier, the one or more destination endpoint group policy identifiers, and the multicast index;
construct the second multicast address using the plurality of entries within the group-based policy matrix; and
construct a multicast forwarding tree to program a forwarding path based on the second multicast address, the programmed forwarding path controlling multicast distribution from the source endpoint group to the one or more destination endpoints.

16. The non-transitory computer-readable storage medium of claim 15, wherein the executable instructions, when executed by the processor, further cause the processor to:
forward the transformed data packet by routing the transformed data packet toward the one or more destination endpoints using the programmed forwarding path.

17. A computing device comprising:
a processor;
a memory resource coupled to the processor, the memory resource including executable instructions that, when executed by the processor, cause the processor to:
receive a group-based policy matrix comprising a source endpoint group policy identifier that identifies a source endpoint group, one or more destination endpoint group policy identifiers identifying one or more destination endpoint groups having included therein one or more destination endpoints, and a multicast index used to specify a multicast forwarding policy between the source endpoint group and the one or more destination endpoint groups;
construct a first multicast address using the source endpoint group policy identifier and the multicast index;
receive an identifier for each network attachment point for each destination endpoint included within the one or more destination endpoint groups; and
program a forwarding path for the first multicast address and using identifiers for each network attachment point, the programmed forwarding path controlling multicast distribution from the source endpoint group to the one or more destination endpoints.

18. The computing device of claim 17, the memory resource including executable instructions that, when executed by the processor, further cause the processor to:
construct the first multicast address to have the source endpoint group policy identifier and the multicast index encoded therein.

19. The computing device of claim 17, the memory resource including executable instructions that, when executed by the processor, further cause the processor to:
receive a data packet from a source endpoint included within the source endpoint group, the data packet comprising a second multicast address;
construct the first multicast address using the source endpoint group policy identifier and the multicast index;
add the first multicast address to the data packet to generate a transformed data packet; and
forward the transformed data packet toward the one or more destination endpoints, the forwarding based on the first multicast address.

20. The computing device of claim 19, the memory resource including executable instructions that, when executed by the processor, further cause the processor to:
forward the transformed data packet by routing the transformed data packet toward the one or more destination endpoints using the programmed forwarding path.
